(19) United States
(12) Patent Application Publication
(10) Pub. No.: US 2015/0242792 A1
(43) Pub. Date: Aug. 27, 2015

(54) SYSTEM AND METHOD FOR MONITORING CUSTOMER EXPERIENCE THROUGH A SERVICE SCENARIO DIAGRAM

(71) Applicant: Tata Consultancy Services Limited, Mumbai (IN)

(72) Inventor: Sachin Ramesh Parandker, Hyderabad (IN)

(21) Appl. No.: 14/630,893

(22) Filed: Feb. 25, 2015

(30) Foreign Application Priority Data
Feb. 25, 2014 (IN) 653/MUM/2014

(51) Int. Cl. G06Q 10/06; G06Q 30/02

(52) U.S. Cl. CPC G06Q 10/06395; G06Q 30/0203

(57) ABSTRACT

Disclosed is a system and a method for facilitating monitoring of customer experience for a service by generating a service scenario diagram. At first, one or more touch-points may be identified corresponding to plurality of stages of a service. Corresponding to each of the touch-points, customer experience data may be captured which indicates perception of the customer towards the service provided. Further, the service scenario diagram may be generated by populating the customer experience data in a predefined format. The service scenario diagram gives a pictorial representation of flow of the services and sub-services. Also, the service scenario diagram helps in capturing analyzed perceptions from both customers's and service provider's perspective. Thus, the service scenario diagram facilitates the monitoring of the customer experience at each of the stages associated with the service.

### CROSS-REFERENCE TO RELATED APPLICATIONS AND PRIORITY

The present application claims priority to Indian Provisional Patent Application No. 653/MUM/2014, filed on Feb. 25, 2014, the entirety of which is hereby incorporated by reference.

### TECHNICAL FIELD

The present subject matter described herein, in general, relates to a method and a system for monitoring customer experience in a service industry.

### BACKGROUND

Understanding customer's need and preferences are essential in a service industry, especially for a customer service organization. Such understanding gives an insight of customer experience while availing a service offered to the customer. In the service industry, there may be different types of domain-specific services offered to the customer. While availing the service, the customer may have to come across different channels of sub-services related to the service. Thus, the travel path or journey of the customer made while availing the services are important to understand customer's view about the services.

The existing tools/techniques available for capturing such customer experience are domain-specific and have limitations in providing in-depth analysis. Further, understanding the working of such tools/techniques becomes difficult for the service providers or users when implemented in different domains. Thus, the process becomes time consuming and tedious for the users using such tools/techniques.

Further, capturing customer's experience data across different sub-services related to the service using these tools and consolidating such data on a common platform to understand the customer's experience is another concern. Analysis of customer's experience data individually over different platforms may not be worthwhile and lead to an increase in internal computing/processing time for these tools. Along with the computation, the whole process becomes complicated and time consuming for the service providers to exactly understand the customer's need in customer's perspective.

### SUMMARY

This summary is provided to introduce aspects related to systems and methods for facilitating monitoring of customer experience for a service and the concepts are further described below in the detailed description. This summary is not intended to identify essential features of subject matter nor it is intended for use in determining or limiting the scope of the subject matter.

In one implementation, a system for facilitating monitoring of customer experience for a service is disclosed. The system comprises a processor and a memory coupled to the processor. The processor executes a plurality of modules stored in the memory. The plurality of modules comprises an identifying module, capturing module, and generating module. The identifying module may identify one or more touch-points corresponding to plurality of stages of a service being availed by a customer. The capturing module may capture customer experience data corresponding to the one or more touch-points when the customer comes across the plurality of stages of the service. The one or more touch-points may indicate an interaction-point being interacted by the customer while availing the service. The customer experience data may indicate a customer perception for the service. The generating module may generate a service scenario diagram by populating the customer experience data in a predefined format. The service scenario diagram may facilitate the monitoring of the customer experience at each of the one or more stages associated with the service.

In another implementation, the method for facilitating monitoring of customer experience for a service is disclosed. The method may comprise identifying, by a processor, one or more touch-points corresponding to plurality of stages of a service being availed by a customer. The method may further comprise capturing, by a processor, customer experience data corresponding to the one or more touch-points when the customer comes across the plurality of stages of the service. The one or more touch-points may indicate an interaction-point being interacted by the customer while availing the service. The customer experience data may indicate a customer perception for the service. Further, the method may comprise generating, by the processor, a service scenario diagram by populating the customer experience data in a predefined format. The service scenario diagram may facilitate the monitoring of the customer experience at each of the one or more stages associated with the service.

In yet another implementation a non-transitory computer readable medium embodying a program executable in a computing device for facilitating monitoring of customer experience for a service. The program may comprise a program code for identifying one or more touch-points corresponding to plurality of stages of a service being availed by a customer. Further, the program may comprise a program code for capturing customer experience data corresponding to the one or more touch-points when the customer comes across the plurality of stages of the service. The one or more touch-points may indicate an interaction-point being interacted by the customer while availing the service. Further, the customer experience data may indicate a customer perception for the service. The program may further comprise a program code for generating a service scenario diagram by populating the customer experience data in a predefined format. Further, the service scenario diagram may facilitate the monitoring of the customer experience at each of the one or more stages associated with the service.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for facilitating monitoring of customer experience for a service, in accordance with an embodiment of the present subject matter.

FIG. 2 illustrates the system, in accordance with an embodiment of the present subject matter.

FIG. 3 illustrates a detailed working of the system, in accordance with an embodiment of the present subject matter.

FIG. 4A-4D illustrates examples for generating service scenario diagrams for different services, in accordance with an embodiment of the present subject matter.

FIG. 5 illustrates a method for facilitating monitoring of customer experience for a service, in accordance with an embodiment of the present subject matter.

### DETAILED DESCRIPTION

Systems and methods for facilitating monitoring of customer experience for a service are disclosed. The present disclosure provides a diagrammatic approach in order to identify customer's experience while availing different services by generating a service scenario diagram. The service scenario diagram may provide a holistic view to the service provider that facilitates the service provider to improve the services provided to the customers. According to aspects of present subject matter, the service scenario diagram may display different stages/scenarios related to the service and their corresponding touch-points.

A customer experience data may be captured and analyzed while the customer comes across these stages/scenarios while availing the service. The present disclosure provides an in-depth analysis of the customer experience in customer's perspective at various scenario/stages of the service. Further, the touch-points may be identified corresponding to each stage/scenario of the service. The touch-points may be considered as an every encounter/interaction (interaction-point) a customer may have with the service. Thus, the customer's experience at the touch-points may be depicted along with analyzed perceptions of the customer. Further, the customer experience data, captured at each touch-point, may be populated in a tabular format for generating the service scenario diagram for the service provider. It may be noted that, the customer experience data may be populated in any other standard format.

While aspects of described system and method for facilitating monitoring of customer experience for a service may be implemented in any number of different computing devices, environments, and/or configurations, the embodiments are described in the context of the following exemplary systems.

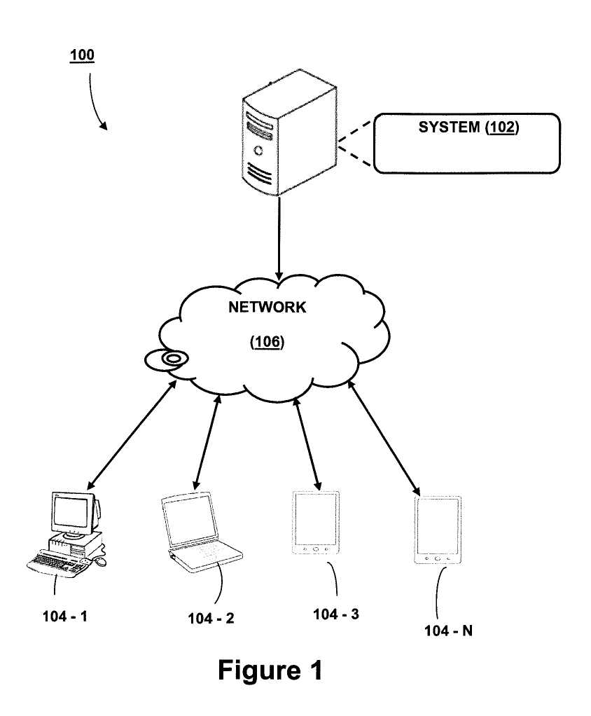

Referring to FIG. 1, a network implementation 100 of system 102 for facilitating monitoring of customer experience for a service, in accordance with an embodiment of the present subject matter. In one embodiment, the system 102 facilitates the monitoring of customer experience for the service by generating a service scenario diagram is illustrated. Although the present subject matter is explained considering that the system 102 is implemented as a software application on a server, it may be understood that the system 102 may also be implemented in a variety of computing systems, such as a laptop computer, a desktop computer, a notebook, a workstation, a mainframe computer, a server, a network server, a tablet, a mobile phone, and the like. In one implementation, the system 102 may be implemented in a cloud-based environment. It will be understood that the system 102 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

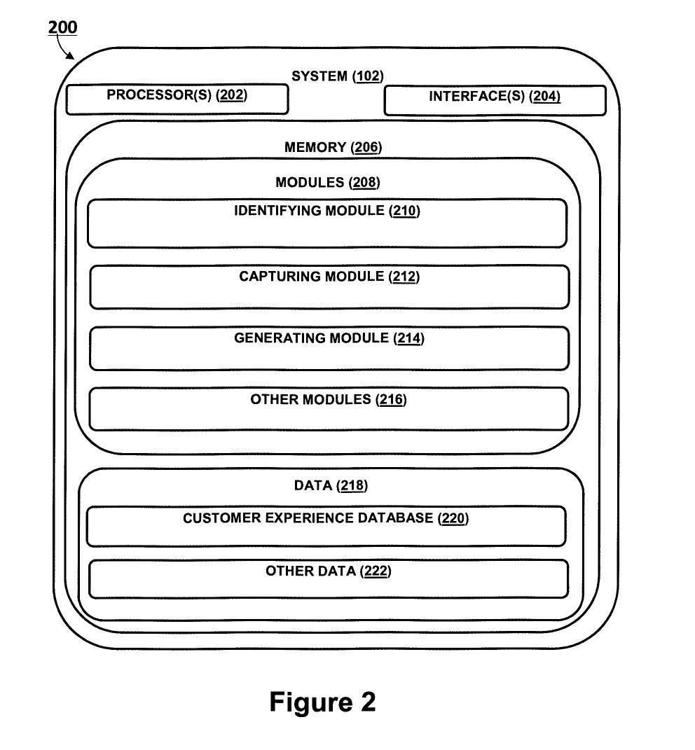

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions or modules stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, a compact disks (CDs), digital versatile disc or digital video disc (DVDs) and magnetic tapes. The memory 206 may include modules 208 and data 218.

The modules 208 include routines, programs, objects, components, data structures, etc., which perform particular tasks or implement particular abstract data types. In one implementation, the modules 208 may include an identifying module 210, a capturing module 212, a generating module 214, and other modules 216. The other modules 216 may include programs or coded instructions that supplement applications and functions of the system 102.

The data 218, amongst other things, serves as a repository for storing data processed, received, and generated by one or more of the modules 208. The data 218 may also include a customer experience database 220, and other data 222.

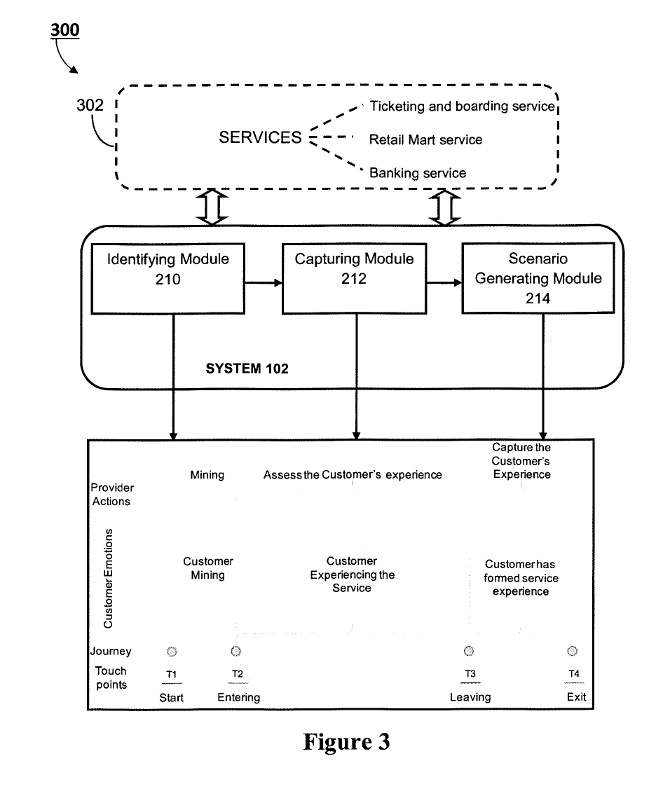

Referring now to FIG. 3 illustrates detailed working of the system, in accordance with an embodiment of the present subject matter. The system 102 is provided for facilitating monitoring of customer experience for a service through a diagrammatic approach by generating a service scenario diagram in order to identify stakeholder details, needs, and action in greater detail. Such approach provides an insight to a service provider to improve upon the services provided to the customers. According to embodiments of present disclosure, the service scenario diagram may facilitate a pictorial representation of the service or a sub-service. Further, the service scenario diagram generated may facilitate to capture a flow of the service along with analyzed perceptions. The analyzed perceptions may be captured from both the customer's perspective and the service provider's perspective.

There may be number of services which may be availed by the customer as shown in FIG. 3, and the service scenario diagram (SSD) can be applied on all these services. Example of these services 302 may include, but not limited to, “ticketing and boarding service”, “retail service”, “banking service”, and “software support service”. At first, the identification module 210 of the system 102 may identify one or more touch-points corresponding to plurality of stages of the service being availed by a customer. The one or more touch-points may indicate an interaction-point being interacted by the customer while availing the service. According to embodiments of present subject matter, the one or more stages for the service may comprise “customer mining stage”, “assessing customer experience stage”, and “capturing customer experience stage”. Corresponding to these stages, the one or more touch-points identified may comprise “start point”, “entering point”, “leaving point”, and “exit point”. It can be seen from the FIG. 3, that with the “customer mining stage”, touch-points may be identified as start point (T1) and entering point (T2) Similarly, with the “accessing customer experience stage”, the touch-points may be identified as entering point (T2) and leaving point (T3). Further, with the “capturing customer experience stage”, touch-points may be identified as leaving point (T3) and exit point (T4).

Among the different stages, the “customer mining stage” may be considered as a pro-active approach of the service provider to influence decision of the customers to avail the services. Further, the “assessing customer experience stage” may indicate a duration during which the customer is experiencing the service and forming an opinion or firming a perception at the touch-points (T2 and T3) associated with the accessing customer experience stage. Similarly, the “capturing customer experience stage” may indicate a stage where the customer is leaving the service and about to exit from service context. At this particular stage (i.e. the “capturing customer experience stage”), the service provider may take an opportunity to assess the customer's experience about the service. A brief conversation with the customer, while he/she is leaving (T3) till he/she exits (T4), can give insight into what the customer's experience has been like.

In the next step, the capturing module 212 of the system 102 may capture customer experience data corresponding to the one or more touch-points when the customer comes across the plurality of stages of the service. The customer experience data captured may indicate a customer perception for the service. Further, the customer experience data may be stored in the customer experience database 220 of the system 102. It may be noted to a person skilled in art, that the capturing module 212 may capture the customer experience data for ‘n’ number of services. Further, the customer experience data may be captured based on a set of parameters associated with the customer. The set of parameters may comprise emotional, cultural, geographical, and psychological parameters. Further, the generating module 214 of the system 102 may generate the service scenario diagram by populating the customer experience data in a predefined format. The service scenario diagram generated may facilitate the monitoring of the customer experience at each of the one or more stages associated with the service. “retail service”, “banking service”, and “software support service”.

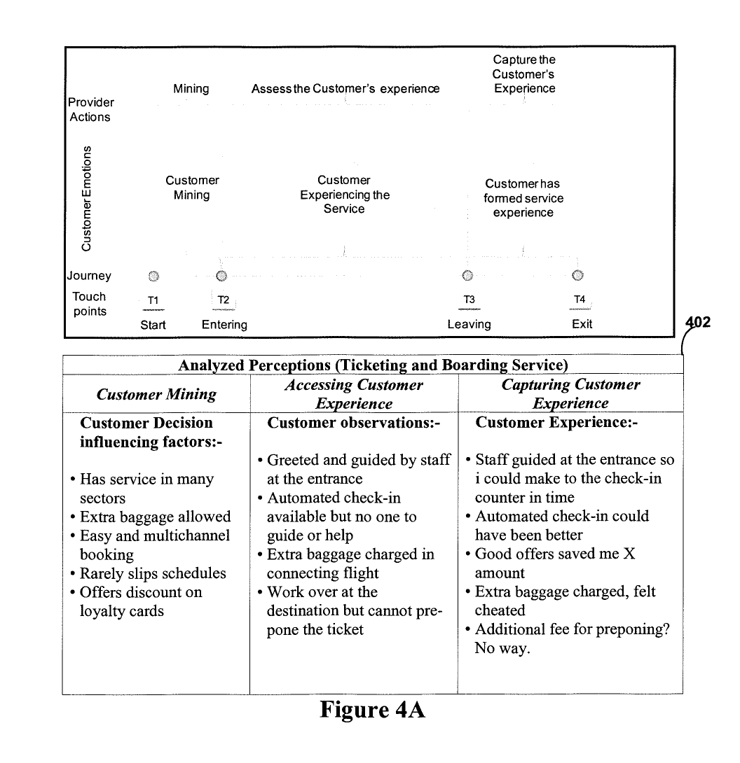

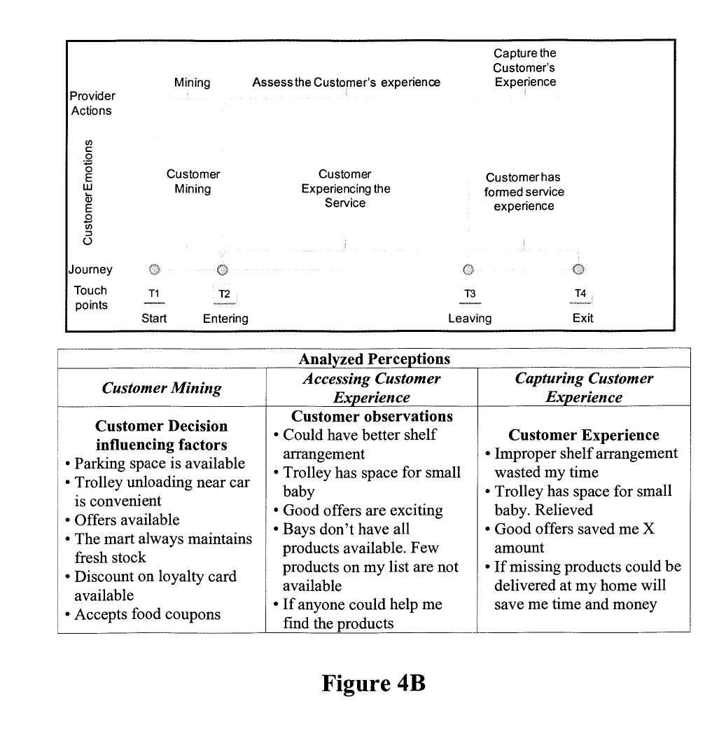

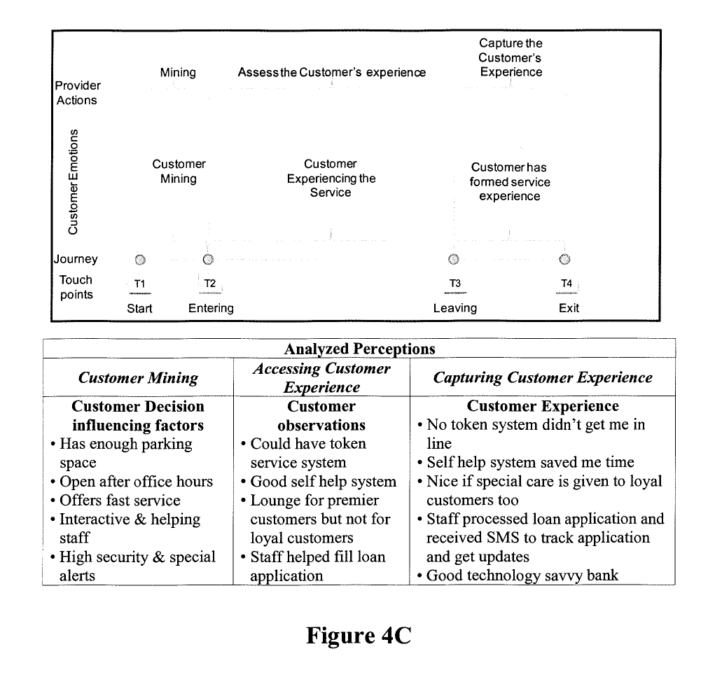

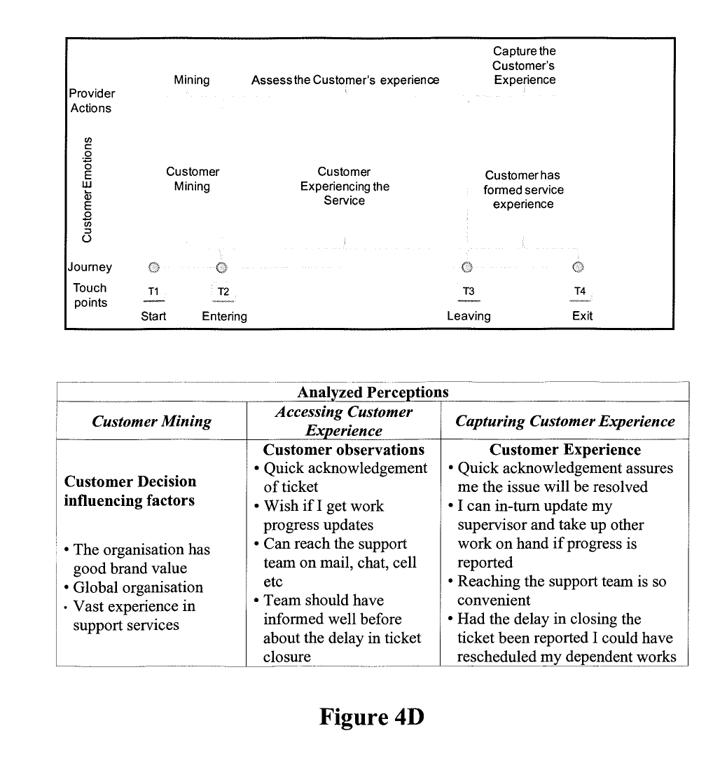

Referring now to FIG. 4A-4D illustrates examples of the service scenario diagram generated by the generating module 214 corresponding to different services. As shown in FIG. 4A, the service scenario diagram may be generated for the “ticketing and boarding service”. The generating module 214 of the system 102 may generate the service scenario diagram by populating the customer experience data in a predefined format. The service scenario diagram generated in such a manner that it indicates the analyzed perceptions of the customer populated in a tabular format 402. In this example, the customer experience data (i.e., the analyzed perception of the customer) captured for the ticketing and boarding service can be seen from the FIG. 4A. From the tabular format 402 of the FIG. 4A, it may be observed that several customer decision influencing factors are listed under the “customer mining stage” of the ticketing and boarding service. Similarly, several customer observations are listed under the “assessing customer experience stage”. Further, for the “capturing customer experience stage”, different customer experience is listed in the tabular format 402. Thus, the service scenario diagram gives an in-depth analysis of the customer experience at various stages of the service availed by the customer. Also, the service scenario diagram facilitates the service provider to monitor the customer experience at each of the stages associated with the service.

Similarly, the service scenario diagram generated for the services “retail service”, “banking service”, and “software support service” may be seen in the FIGS. 4B, 4C, and 4D respectively. With each service scenario diagrams, the customer perceptions at different stages of the service may be seen from the figures.

Further, the present disclosure considers the perceptions of both the customer and the service provider. The service scenario diagram enables the identification of customer experience Indicator (CXi) level. The CXi may be considered as basic unit level of the analysis and hence done at the deepest level. While generating the service scenario diagram different factors like emotional, cultural, geographical, psychological etc., may be considered. The analysis methodology for generating the service scenario diagram may be generic and is applicable across industries. Thus, the service scenario diagram represents the simplest form of pictorial representation which avoids complications by limiting the number of stakeholder/business process analysis which gives better control over analyzing the business.

Further, the one or more logical sub-services from the service provided by the service provider may also get identified. In one embodiment of present subject matter, the logical sub-services identified may be as follows:

1. Entry point at the service provider.

2. Preceding sub-service (Pss) at the entry point. (if any)

3. Exit point at the customer (internal customer).

4. Succeeding sub-service (Sss). (if any)

5. Frequency and time period of the sub-service. and

6. Dependent & support services of the sub-service. (if any)

Thus, the flow of the service and analyzed perception of the customer are captured through the service scenario diagram. The service provider may utilize the analyzed perceptions to improve over their services according to customer's perspective.

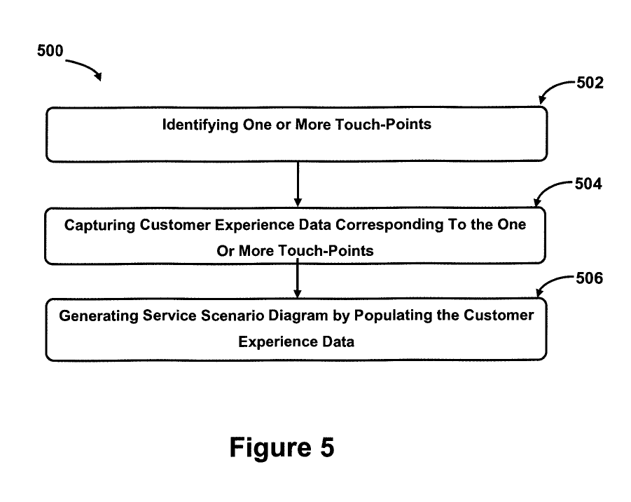

Referring now to FIG. 5, the method for facilitating monitoring of customer experience for a service is shown, in accordance with an embodiment of the present subject matter. The method 500 may be described in the general context of computer executable instructions. Generally, computer executable instructions can include routines, programs, objects, components, data structures, procedures, modules, functions, etc., that perform particular functions or implement particular abstract data types. The method 500 may also be practiced in a distributed computing environment where functions are performed by remote processing devices that are linked through a communications network. In a distributed computing environment, computer executable instructions may be located in both local and remote computer storage media, including memory storage devices.

The order in which the method 500 is described is not intended to be construed as a limitation, and any number of the described method blocks can be combined in any order to implement the method 500 or alternate methods. Additionally, individual blocks may be deleted from the method 500 without departing from the spirit and scope of the subject matter described herein. Furthermore, the method can be implemented in any suitable hardware, software, firmware, or combination thereof. However, for ease of explanation, in the embodiments described below, the method 500 may be considered to be implemented in the above described system 102.

At block 502, one or more touch-points corresponding to plurality of stages of a service, being availed by a customer, may be identified. The plurality of stages may comprise customer mining stage, accessing customer experience stage, and capturing customer experience stage. Further, the one or more touch-points may comprise a start point, an entering point, a leaving point, and an exit point.

At block 504, customer experience data corresponding to the one or more touch-points may be captured when the customer comes across the plurality of stages of the service. Further, the one or more touch-points may indicate an interaction-point being interacted by the customer while availing the service. Further, the customer experience data may indicate a customer perception for the service.

At block 506, a service scenario diagram may be generated by populating the customer experience data in a predefined format. The service scenario diagram may facilitate the monitoring of the customer experience at each of the one or more stages associated with the service.

Although implementations for methods and systems for facilitating monitoring of customer experience for a service have been described in language specific to structural features and/or methods, it is to be understood that the appended claims are not necessarily limited to the specific features or methods described. Rather, the specific features and methods are disclosed as examples of implementations for facilitating monitoring of customer experience for a service by generating the service scenario diagram

We claim:

1. A method for facilitating monitoring of customer experience for a service, the method comprising:
identifying, by a processor, one or more touch-points corresponding to plurality of stages of a service being availed by a customer;
capturing, by a processor, customer experience data corresponding to the one or more touch-points when the customer comes across the plurality of stages of the service, wherein one or more touch-points indicates an interaction-point being interacted by the customer while availing the service, and wherein the customer experience data indicates a customer perception for the service; and
generating, by the processor, a service scenario diagram by populating the customer experience data in a predefined format, wherein the service scenario diagram facilitates the monitoring of the customer experience at each of the one or more stages associated with the service.

2. The method of claim 1, wherein the customer experience data is captured based on a set of parameters associated with the customer, wherein the set of parameters comprises emotional, cultural, geographical, and psychological.

3. The method of claim 1, wherein the plurality of stages comprises customer mining stage, assessing customer experience stage, and capturing customer experience stage.

4. The method of claim 1, wherein the one or more touch-points comprises a start point, an entering point, a leaving point, and an exit point.

5. A system 102 for facilitating monitoring of customer experience for a service, the system comprises:
a processor 202;
a memory 206 coupled with the processor 202, wherein the processor 202 executes a plurality of modules 208 stored in the memory 206, and wherein the plurality of modules 208 comprising:
identifying module 210 to identify one or more touch-points corresponding to plurality of stages of a service being availed by a customer;
capturing module 212 to capture customer experience data corresponding to the one or more touch-points when the customer comes across the plurality of stages of the service, wherein one or more touch-points indicates an interaction-point being interacted by the customer while availing the service, and wherein the customer experience data indicates a customer perception for the service; and
generating module 214 to generate a service scenario diagram by populating the customer experience data in a predefined format, wherein the service scenario diagram facilitates the monitoring of the customer experience at each of the one or more stages associated with the service.

6. The system 102 of claim 5, wherein the customer experience data is captured based on a set of parameters associated with the customer, wherein the set of parameters comprises emotional, cultural, geographical, and psychological.

7. The system 102 of claim 5, wherein the plurality of stages comprises customer mining stage, assessing customer experience stage, and capturing customer experience stage.

8. The system 102 of claim 5, wherein the one or more touch-points comprises a start point, an entering point, a leaving point, and an exit point.

9. A non-transitory computer readable medium embodying a program executable in a computing device for facilitating monitoring of customer experience for a service, the program comprising:
a program code for identifying one or more touch-points corresponding to plurality of stages of a service being availed by a customer;
a program code for capturing customer experience data corresponding to the one or more touch-points when the customer comes across the plurality of stages of the service, wherein one or more touch-points indicates an interaction-point being interacted by the customer while availing the service, and wherein the customer experience data indicates a customer perception for the service; and
a program code for generating a service scenario diagram by populating the customer experience data in a predefined format, wherein the service scenario diagram facilitates the monitoring of the customer experience at each of the one or more stages associated with the service.
